(19) United States
(12) Patent Application Publication
(10) Pub. No.: US 2017/0101606 A1
(43) Pub. Date: Apr. 13, 2017

(54) Use Of N-Methyl-N-Acylglucamine As Corrosion Inhibitor

(71) Applicant: Clariant International Ltd., Muttenz (CH)

(72) Inventors: Peter KLUG, Grossostheim (DE); Rainer KUPFER, Hattersheim (DE); Steffen FLEISCHER, Romrod (DE)

(73) Assignee: Clariant International Ltd., Muttenz (CH)

(21) Appl. No.: 15/123,065

(22) PCT Filed: Feb. 26, 2015
(86) PCT No.: PCT/EP2015/000442

§ 371 Date: Sep. 1, 2016

(30) Foreign Application Priority Data
Mar. 6, 2014 (DE) 102014003367.8

(51) Int. Cl. C11D 11/00; C11D 3/32; C10M 133/16; C23F 11/10; C23F 11/14

(52) U.S. Cl. CPC C11D 11/0029; C23F 11/10; C23F 11/14; C10M 133/16; C11D 3/32; C10N 2240/40; C10M 2215/082

(57) ABSTRACT

The invention relates to the use of one or more M-methyl-N-acylglucamines of the formula (I) wherein R¹ represents a linear or branched, saturated or unsaturated hydrocarbon group having 7 to 21 carbon atoms, as a corrosion inhibitor.

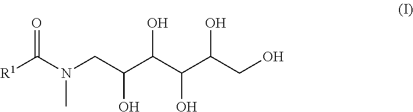

The invention relates to the use of N-methyl-N-acylglucamine as corrosion inhibitor.

Compositions having a corrosion-inhibiting effect are being sought in different applications, for example for the production of aqueous metal treatment and metalworking fluids, especially of anticorrosive, detergent and cooling lubricant emulsions. Corrosion inhibitors are intended to protect metals, for example iron, aluminum, zinc, copper or alloys thereof, from corrosion during industrial steps of processing the metal parts and prevent formation of rust.

A multitude of inorganic and organic compounds are known as water-soluble corrosion inhibitors. Inorganic corrosion inhibitors may be based, for example, on chromates, nitrites or phosphates, but these are disadvantageous to a greater or lesser degree for toxicological and environmental reasons. Organic corrosion inhibitors are frequently based on carboxylates, amines, amides, or nitrogen-containing heterocyclic compounds.

Polyhydroxy fatty acid amides and the use thereof as nonionic surfactant in washing and cleaning compositions are described in numerous specifications.

WO 9412609 teaches washing and cleaning compositions comprising polyhydroxy fatty acid amide having good cleaning action, especially against greasy stains on textiles or ware.

WO 9841601 teaches cleaning compositions comprising polyhydroxy fatty acid amide, which remove greasy and oily soil on cooking utensils and are noncorrosive.

WO 9523840 teaches cleaning compositions comprising polyhydroxy fatty acid amide, which feature good color protection.

EP 0745719 describes the use of carbohydrate compounds, including polyhydroxy fatty acid amides, as auxiliary for coloring or printing fiber materials with fiber-reactive dyes.

It was an object of the present invention to provide water-soluble corrosion inhibitors which are superior to the known corrosion inhibitors, particularly with regard to environmental compatibility, and exhibit very good corrosion-inhibiting action.

It has been found that, surprisingly, N-methyl-N-acylglucamines, in the presence of water, exhibit significant corrosion-inhibiting action on metal surfaces and additionally feature good environmental compatibility and safe use.

The invention therefore provides for the use of one or more N-methyl-N-acylglucamines of the formula (I)

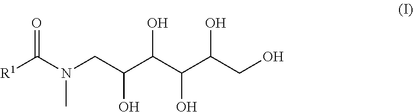

in which R¹ is a linear or branched, saturated or unsaturated hydrocarbyl group having 7 to 21 carbon atoms as corrosion inhibitor.

Further names for N-methyl-N-acylglucamine are N-methyl-N-1-deoxysorbitol fatty acid amide, N-acyl-N-methylglucamine, glucamide or N-methyl-N-alkylglucamide.

N-Methyl-N-acylglucamines of the formula (I) are effective in protecting metal surfaces from corrosion, are surface-active, and have high water dispersibility which is indispensable for the formulation of aqueous concentrates for metal treatment and metalworking fluids.

The invention further provides for the use of one or more N-methyl-N-acylglucamines of the formula (I) for production of oily water-miscible emulsion concentrates which, through dilution with water, afford ready-to-use anticorrosive, detergent and cooling lubricant emulsions.

The invention further provides for the use of one or more N-methyl-N-acylglucamines of the formula (I) as a constituent of anticorrosion compositions, detergents for metals and cooling lubricant emulsions.

The invention further provides a method of preventing or attenuating the formation of corrosion on metal surfaces, by contacting the metal surface with one or more N-methyl-N-acylglucamines of the formula (I).

In a preferred embodiment, R¹ is an aliphatic group.

In a preferred embodiment of the invention, R¹ is a linear or branched, saturated or unsaturated hydrocarbyl group having 11 to 17 carbon atoms. More particularly, R¹ is a linear or branched alkyl or alkenyl group. More preferably, R¹ is a linear saturated or unsaturated C₁₁, C₁₃, C₁₅ or C₁₇ radical, especially an unsaturated C₁₇ radical.

A particularly preferred embodiment of the invention is the use of a mixture of at least 2 to 6N-methyl-N-acylglucamines of the formula (I), where the 2 to 6 different N-methyl-N-acylglucamines have different acyl groups (—CO R¹).

A particularly preferred embodiment of the invention is the use of N-methyl-N-acylglucamines of the formula (I), where these contain, to an extent of at least 80% by weight, a mixture of N-methyl-N—C₁₂-acylglucamine and N-methyl-N—C₁₄-acylglucamine.

A further particularly preferred embodiment of the invention is the use of N-methyl-N-acylglucamines of the formula (I), where these contain, to an extent of at least 80% by weight, a mixture of N-methyl-N—C₁₆-acylglucamine and N-methyl-N—C₁₈-acylglucamine.

The N-acyl-N-methylglucamines of formula (I) can be prepared in the manner described in EP 0550637 from the corresponding fatty acid methyl esters and N-methylglucamine. The fatty acids of the fatty acid methyl esters are preferably selected from the group comprising 9-octadecenoic acid (oleic acid), octadeca-9,12-dienoic acid (linoleic acid), octanoic acid (caprylic acid), decanoic acid (capric acid), dodecanoic acid (lauric acid), tetradecanoic acid (myristic acid), hexadecanoic acid (palmitic acid), octadecanoic acid (stearic acid) and n-docosanoic acid (behenic acid).

Particular preference is given to the use of one or more N-acyl-N-methylglucamines of the formula I) as corrosion inhibitor in compositions comprising at least one or more than one organic acid of the formula (II), or salts thereof,

R²—COOM (II)

in which
R² is a linear or branched alkyl group or a linear or branched, mono- or polyunsaturated alkenyl group having 5 to 29 carbon atoms, and
M is hydrogen or one or more cations, where the cations are present in charge-balancing amounts,
   and
   c) one or more alkanolamines of the formula (III)

NR¹R²R³ (III)

in which

R¹, R² and R³ are hydrogen, a linear or branched alkyl group having 1 to 4 carbon atoms, a cycloalkyl group having 5 to 7 carbon atoms, a linear or branched hydroxyalkyl group having 2 to 5 carbon atoms and 1 or 2 hydroxyl groups or a hydroxy ether group having 2 to 6 carbon atoms, with the proviso that at least one of the radicals is a hydroxyalkyl group or a hydroxy ether group.

These compositions are preferably used to produce oily water-miscible emulsion concentrates which, through dilution with water, afford ready-to-use anticorrosive, detergent and cooling lubricant emulsions.

In a preferred embodiment, R² in the formula (II) is an alkyl or alkenyl radical having 9 to 21 carbon atoms.

The one or more organic acids of the formula (II) present in the compositions, or salt(s) thereof, are preferably selected from: caprylic acid, pelargonic acid, capric acid, lauric acid, myristic acid, palmitic acid, margaric acid, stearic acid, arachic acid, behenic acid, lignoceric acid, cerotic acid, montanic acid, melissic acid, undecylenoic acid, myristoleic acid, palmitoleic acid, petroselic acid, oleic acid, elaidic acid, vaccenic acid, gadoleic acid, eicosenoic acid, cetoleic acid, erucic acid, nervonic acid, linoleic acid, α-linolenic acid, γ-linolenic acid, calendic acid, punicinic acid, α-eleostearic acid, β-eleostearic acid, arachidonic acid, eicosapentaenoic acid, clupanodonic acid, docosahexaenoic acid, vernolic acid, ricinoleic acid and salts thereof, especially coconut, palm kernel, olive oil, tall oil (TOFA) or tallow fatty acids and salts thereof, and also naphthenic acid and salts thereof. Preference is given to using fatty acid salts in the form of Li⁺, Na⁺, K⁺, Mg⁺⁺, Ca⁺⁺, Al⁺⁺⁺ and/or NH₄⁺ salts. Preference is likewise given to the monoalkylammonium, dialkylammonium, trialkylammonium and/or tetraalkylammonium salts, where the alkyl substituents of the amines may each independently be (C₁-C₂₂)-alkyl radicals which may optionally be occupied by up to 3 (C₂-C₁₀)-hydroxyalkyl groups.

Particular preference is given to the use of one or more N-acyl-N-methylglucamines of the formula (I) as corrosion inhibitor in compositions comprising a tall oil fatty acid (TOFA) and/or a coconut fatty acid (CC) or salts thereof. Tall oil fatty acid (TOFA), as described in RÖMPP (online ID=RD-20-00149), is a monocarboxylic acid of the formula (II) having predominantly mono-, di- and triunsaturated C₁₈ carbon chains. Coconut fatty acid is composed mainly of C₈-C₁₈ fatty acids, predominantly caprylic, lauric, capric, palmitic, stearic, myristic and oleic acid.

Particular preference is further given to the use of one or more N-acyl-N-methylglucamines of the formula (I) as corrosion inhibitor in compositions comprising one or more alkanolamines of the formula (III) selected from monoethanolamine HOCH₂CH₂NH₂, diethanolamine (HOCH₂CH₂)₂NH, triethanolamine (HOCH₂CH₂)₃N, monoisopropanolamine CH₃CHOHCH₂NH₂, 2-amino-2-methyl-1-propanol HOCH₂C(CH₃)₂NH₂, 2-amino-1-butanol CH₃CH₂CHNH₂CH₂OH, diglycolamine HOCH₂—CH₂OCH₂CH₂NH₂, methylethanolamine HOCH₂CH₂N(CH₃)H, dimethylethanolamine HOCH₂CH₂N(CH₃)₂, methyldiethanolamine (HOCH₂CH₂)₂NCH₃, ethylaminoethanol HOCH₂CH₂N(H)(CH₂CH₃), diethylaminoethanol HOCH₂CH₂N(CH₂CH₃)₂, 2-amino-2-ethylpropane-1,3-diol HOCH₂C(C₂H₅)NH₂CH₂OH, dimethylamino-2-propanol CH₃CHOHCH₂N(CH₃)₂, isopropylaminoethanol HOCH₂CH₂N(H)(CH(CH₃)₂), isopropylaminodiethanol (HOCH₂CH₂)₂N(CH(CH₃)₂), diisopropylaminoethanol HOCH₂CH₂N(CH(CH₃)₂)₂, n-butylaminoethanol HOCH₂CH₂N(H)((CH₂)₃CH₃), dibutylaminoethanol HOCH₂CH₂N(((CH₂)₃CH₃)₂, n-butyldiethanolamine (HOCH₂CH₂N(((CH₂)₃CH₃)₂, t-butylethanol HOCH₂CH₂NHCCH₃)₃ and N-cyclohexyldiethanolamine (HOCH₂CH₂)₂N(C₆H₁₁).

Exceptionally preferred is the use of one or more N-acyl-N-methylglucamines of the formula (I) as corrosion inhibitor in compositions comprising one or more alkanolamines of the formula (III) selected from monoethanolamine, diethanolamine, triethanolamine, diglycolamine, monoisopropanolamine and 2-amino-2-methyl-1-propanol and mixtures thereof.

A further particular embodiment of the invention is the use of one or more N-acyl-N-methylglucamines of the formula (I) as corrosion inhibitor in compositions comprising at least one organic acid, or salt thereof, of formula (II) and at least one alkanolamine of formula (III), characterized in that the composition contains
a) 1% to 50% by weight of one or more methylglucamines of the formula (I),
b) 0.1% to 23% by weight of at least one organic acid, or salt thereof, of formula (II) and
c) 0.05% to 42% by weight of at least one alkanolamine of formula (III) and
d) ad 100% by weight further components.

In a further preferred embodiment, the inventive use is effected with further components selected from one or more emulsifiers, one or more biocides, one or more further corrosion inhibitors, one or more AW additives, one or more EP additives, one or more defoamers, one or more antioxidants, one or more coupling agents, one or more alkali metals or alkaline earth metals, one or more solubilizers, pH regulators, mineral oils and water.

The emulsifiers are preferably selected from anionic, nonionic, cationic and amphoteric emulsifiers. Preference is given to anionic and/or nonionic emulsifiers.

Useful anionic emulsifiers include:
sulfonates, especially petroleumsulfonates, olefinsulfonates, i.e. mixtures of alkene- and hydroxyalkanesulfonates, and disulfonates as obtained, for example, from C₁₂-C₁₈-monoolefins having a terminal or internal double bond by sulfonation with gaseous sulfur trioxide and subsequent alkaline or acidic hydrolysis of the sulfonation products, C₁₂-C₁₈-alkanesulfonates, secondary alkanesulfonates, C₉-C₁₃-alkylbenzenesulfonates, α-naphthylsulfonates, and the esters of [α]-sulfo fatty acids (ester sulfonates), for example the [α]-sulfonated methyl esters of hydrogenated coconut, palm kernel or tallow fatty acids.
Sulfates, especially alk(en)yl sulfates, such as the alkali metal and especially the sodium salts of the sulfuric monoesters of C₁₂-C₁₈ fatty alcohols, for example of coconut fatty alcohol, tallow fatty alcohol, lauryl, myristyl, cetyl or stearyl alcohol, or of the C₁₀-C₂₀ oxo process alcohols, and also alk(en)yl ether sulfates, preferably the sulfuric monoesters of the straight-chain or branched C₇-C₂₁ alcohols ethoxylated with 1 to 6 mol of ethylene oxide, such as 2-methyl-branched C₉-C₁₁ alcohols.
Carboxylates, such as fatty acid soaps, especially the salts of lauric acid, myristic acid, palmitic acid, stearic acid, (hydrogenated) erucic acid and behenic acid, and especially soap mixtures derived from natural fatty acids, for example coconut, palm kernel, olive oil or tallow fatty acids. Naphthenic acid soaps.
Alkyl ether carboxylates of the formula (IV)

RO—(CH₂CH₂O—)ₙCH₂—COOM (IV)
where
R is a linear or branched hydrocarbon group which is saturated or unsaturated by one or more double bonds and has 8 to 22 carbon atoms,
n is a number from 1 to 20, and
M is a counterion,
alkenylimidosuccinic acid carboxylate
fatty acid amides
phosphoric esters, alkoxylated phosphoric esters.

The anionic emulsifiers may be present in the form of their sodium, potassium or magnesium or ammonium salts.

Anionic emulsifiers are preferably used in amounts of 0% by weight to 50% by weight, preferably 0.5% by weight to 40% by weight, more preferably 1.0% by weight to 30% by weight, based on the composition consisting of components a) to d).

Useful nonionic emulsifiers include:
alkoxylated fatty alcohols, advantageously ethoxylated, especially primary alcohols having preferably 8 to 18 carbon atoms and an average of 1 to 12 mol of ethylene oxide (EO) per mole of alcohol, in which the alcohol residue may be linear or preferably 2-methyl-branched. The preferred ethoxylated alcohols include, for example, C₁₂-C₁₄ alcohols with 3 EO, 4 EO or 7 EO, C₉-C₁₁ alcohol with 7 EO, C₁₃-C₁₅ alcohols with 3 EO, 5 EO, 7 EO or 8 EO, C₁₂-C₁₈ alcohols with 3 EO, 5 EO or 7 EO and mixtures of these, such as mixtures of C₁₂-C₁₄ alcohol with 3 EO and C₁₂-C₁₈ alcohol with 7 EO, as typically present in oxo process alcohol radicals.
Methyl esters of alkoxylated C₈-C₂₂ fatty acids having 1 to 100 alkoxy groups, where the alkoxy groups may consist of one or different units selected from CH₂CH₂O, C₃H₆O and C₄H₈O.
Fatty acid amides of the formula (V)

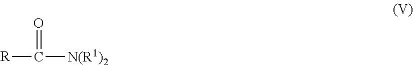

in which
R is an alkyl group having 7 to 21, preferably 9 to 17, carbon atoms and
each R¹ radical is hydrogen, C₁-C₄-alkyl, C₁-C₄-hydroxyalkyl or (C₂H₄O)ₓH where
x is 1, 2 or 3.
Preference is given to C₈-C₂₀ amides, monoethanolamides, diethanolamides and isopropanolamides.
Alkylphenol polyglycol ethers, preferably the condensation products of alkylphenols having a C₆- to C₂₀-alkyl group which may be linear or branched, with alkylene oxides.
Amine oxides of the formula (VI)

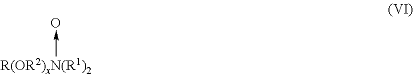

in which
R is an alkyl, hydroxyalkyl or alkylphenol group having a chain length of 8 to 22 carbon atoms,
R² is an alkylene or hydroxyalkylene group having 2 to 3 carbon atoms or mixtures thereof,
each R¹ radical is an alkyl or hydroxyalkyl group having 1 to 3 carbon atoms or a polyethylene oxide group having 1 to 3 ethylene oxide units and
x is a number from 0 to 10.
Alkyl polyglycosides of the formula (VII)

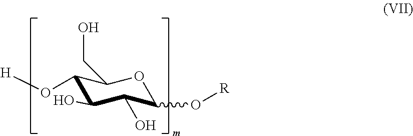

where R is a primary straight-chain or methyl-branched, especially 2-methyl-branched, aliphatic radical having 8 to 22, preferably 12 to 18 carbon atoms, and m is 1 to 5.

Nonionic emulsifiers are preferably used in amounts of 0% by weight to 50% by weight, preferably 0.5% by weight to 30% by weight, more preferably 1.0% by weight to 20% by weight, based on compositions consisting of components a) to d).

Cationic and amphoteric emulsifiers are preferably used in amounts of 0% by weight to 50% by weight, preferably 0.5% by weight to 40% by weight, more preferably 1.0% by weight to 35% by weight, based on the compositions consisting of components a) to d).

Aqueous metal treatment and metalworking fluids are an ideal habitat for microorganisms. In an aqueous medium, at favorable temperatures, an oversupply of nutrients is present. Uninhibited microbial growth leads to degradation of individual components, alters the pH and consequently destabilizes the emulsion. In addition, deposits of biological material can lead to shortening of the cooling lubricant service life in a bath. The effect of biocides is to kill off bacteria, yeasts and fungi.

A preferred embodiment of the invention is therefore the use of N-methyl-N-acylglucamines of the formula (I) in compositions composed of fatty acids or salts thereof, alkanolamines and at least one or more than one biocide.

The biocides may be selected from: N-(3-aminopropyl)-N-dodecylpropane-1,3-diamine, 1-aza-3,7-dioxa-5-ethylbicyclo[3.3.0]octane, 5-ethyl-3,7-dioxa-1-azabicyclo[3.3.0]octane 1,2-benzisothiazol-3(2H)-one (BIT) benzyl alcohol mono(poly)hemiformal ((benzyloxy)methanol) biphenyl-2-ol (2-phenylphenol) 1,3-bis(hydroxymethyl)-5,5-dimethylimidazolidine-2,4-dione (1,3-dimethylol-5,5-dimethylhydantoin, DMDMH) bismorpholinomethane, 4,4′-methylenebismorpholine 2-butylbenzo[d]isothiazol-3-one (BBIT) cis-1-(3-chloroallyl)-3,5,7-triaza-1-azoniaadamantane chloride (cis-CTAC) p-chloro-m-cresol (4-chloro-3-methylphenol, chlorocresol) 5-chloro-2-methyl-2,3-dihydroisothiazol-3-one/2-methyl-2,3-dihydroisothiazol-3-one (3(2H)-isothiazolone, 5-chloro-2-methyl, mixture with 2-methyl-3(2H)-isothiazolone) (CMI/MI, CMIT/MIT) N-cyclohexylhydroxydiazene 1-oxide, potassium salt (N-cyclohexyl-N-nitroso-hydroxylamine, potassium salt, (N-cyclohexyldiazeniumdioxy)potassium, K-HDO) 2,2-dibromo-2-cyanacetamide (2,2-dibromo-3-nitrilopropionamide, DBNPA) 1,6-dihydroxy-2,5-dioxahexane ((ethylenedioxy)dimethanol) 4,4′-dimethyloxazolidine 1,3-dimethylol-5,5-dimethylhydantoin—see 1,3-bis(hydroxymethyl)-5,5-dimethylimidazolidine-2,4-dione 5-ethyl-3,7-dioxa-1-azabicyclo[3.3.0]octane (7a-ethyldihydro-1H,3H,5H-oxazolo-[3,4-c]-oxazole, 1-aza-3,7-dioxa-5-ethylbicyclo[3.3.0]octane) (EDHO) (ethylenedioxy)dimethanol, 1,6-dihydroxy-2,5-dioxahexane glutaraldehyde (glutaral) (2,2′,2″-(hexahydro-1,3,5-triazine-1,3,5-triyl)triethanol)—see 1,3,5-tris(2-hydroxyethyl)hexahydro-1,3,5-triazine hexamethylenetetramine-3-chloroallyl chloride (methenamine-3-chloroallyl chloride, (1,3,5,7-tetraaza-1-(3-chloroprop-2-enyl)tricyclo[3.3.1.1|<3,7>decane chloride, CTAC 3-iodo-2-propynyl butyl carbamate (IPBC) methenamine-3-chloroallyl chloride, hexamethylenetetramine-3-chlorallyl chloride 2-methyl-2,3-dihydroisothiazol-3-one (2-methyl-2H-isothiazol-3-one, MI, MIT) 3,3′-methylenebis(5-methyloxazolidine) (MBO) 4,4′-methylenebismorpholine (N,N′-methylenebismorpholine, methylenebis-(tetrahydro-1,4-oxazine), bismorpholinomethane) sodium pyrithione, pyridine-2-thiol 1-oxide, sodium salt 2-n-octyl-2,3-dihydroisothiazol-3-one (2-octyl-2H-isothiazol-3-one) (OIT, “octhilinone”) 4-(2-nitrobutyl)morpholine 2-phenoxyethanol 2-phenylphenol, biphenyl-2-ol pyridine-2-thiol 1-oxide, sodium salt (“sodium pyrithione”) 1,3,5,7-tetraaza-1-(3-chloroprop-2-enyl)tricyclo[3.3.1.1<3,7>]decane chloride, hexamethylenetetramine-3-chloroallyl chloride 1,3,4,6-tetra(hydroxymethyl)-[3aH,6aH]-1,3,4,6-tetraazabicyclooctane-2,5-dione (tetrahydro-1,3,4,6-tetrakis(hydroxymethyl)imidazo[4,5-d]imidazole-2,5(1H,3H)-dione, TMAD) 1,3,5-tris(2-hydroxyethyl)hexahydro-1,3,5-triazine (2,2′,2″-(hexahydro-1,3,5-triazine-1,3,5-triyl)triethanol, HHT) 1,3,5-tris(2-hydroxypropyl)hexahydro-1,3,5-triazine (a,a′,a″-trimethyl-1,3,5-triazine-1,3,5(2H,4H,6H)-triethanol) 6-acetoxy-2,4-dimethyl-m-dioxane-2,6-dimethyl-1,3-dioxan-4-yl acetate alkyl(C₁₂-C₁₄)[(ethylphenyl)methyl]dimethylammonium chloride (stoichiometric) N-alkyl(C₁₀-C₁₆)trimethylenediamine and reaction products with chloroacetic acid 1-[2-(allyloxy)-2-(2,4-dichlorophenyl)ethyl]-1H-imidazole (“imazalil”) (+/−)1-[2-(β-allyloxy)-2-(2,4-dichlorophenyl)ethyl]-1H-imidazole (“technical grade imazalil”) aluminum sodium silicate-silver complex/silver zeolite formic acid Bardap 26, poly(oxy-1,2-ethanediyl)-a-[2-(didecylmethylammonium)ethyl]-w-hydroxypropionate benzothiazole-2-thiol (benzothiazol-2-ylthio)methyl thiocyanate (“TCMTB”) 3-benzo(b)thien-2-yl-5,6-dihydro-1,4,2-oxathiazine 4-oxide (“bethoxazin”) benzylalkyl(C₁₂-C₁₄)dimethylammonium chloride benzylalkyl(C₁₂-C₁₆)dimethylammonium chloride benzylalkyl(C₁₂-C₁₈)dimethylammonium chloride benzylalkyl(C₁₂-C₁₈ saturated and unsaturated, tallowalkyl, cocoalkyl, soyaalkyl)dimethylammonium chlorides, bromides or hydroxides bethoxazin, 3-benzo(b)thien-2-yl-5,6-dihydro-1,4,2-oxathiazine 4-oxide bis(3-aminopropyl)octylamine 1,3-bis(hydroxymethyl)urea (1,3-dimethylolurea) 1,3-bis(hydroxymethyl)urea, reaction products with 2-(2-butoxyethoxy)ethanol, ethylene glycol and formaldehyde (“formaldehyde depot alpha”) BKC, benzylalkyldimethylammonium chlorides, bromides or hydroxides 2-bromo-2-(bromomethyl)pentanedinitrile, 1,2-dibromo-2,4-dicyanobutane 4-bromo-2-(4-chlorophenyl)-1-(ethoxymethyl)-5-(trifluoromethyl)-1H-pyrrole-3-carbonitrile (“chlorfenapyr”) 1,3-bromochloro-5,5-dimethylimidazolidine-2,4-dione (bromochloro-5,5-dimethylhydantoin) 2-bromo-2-nitropropane-1,3-diol (“bronopol”) (2-bromo-2-nitrovinyl)benzene 2-tert-butylaminoethyl methacrylate, homopolymer cis-4-[3-(p-tert-butylphenyl)-2-methylpropyl]-2,6-dimethylmorpholine (“fenpropimorph”) carbendazim, 2-(methoxycarbonylamino)benzimidazole [2-[[2-[(2-carboxyethyl)(2-hydroxyethyl)amino]ethypamino]-2-oxoethyl]cocoalkyl-dimethylammonium hydroxides, internal salts (quaternary ammonium compounds) 2-chloroacetamide 3-(3-chloro-4-methylphenyl)-1,1-dimethylurea (“chlortoluron”) chlorfenapyr, 4-bromo-2-(4-chlorophenyl)-1-(ethoxymethyl)-5-(trifluoromethyl)-1H-pyrrole-3-carbonitrile DDAC, dialkyldimethylammonium chlorides, bromides or methylsulfates dialkyl(C₈-C₁₀)dimethylammonium chlorides dialkyl(C₆-C₁₈ saturated and unsaturated, tallowalkyl, cocoalkyl, soyaalkyl)-dimethylammonium chlorides, bromides or methylsulfates (DDAC) 1,2-dibromo-2,4-dicyanobutane (2-bromo-2-(bromomethyl)pentanedinitrile) 2,4-dichlorobenzyl alcohol (2,4-dichlorophenylmethanol) dichlorophene, 2,2′-methylenebis(4-chlorophenol)phenol 1-[[2-(2,4-dichlorophenyl)-4-propyl-1,3-dioxolan-2-yl]methyl]-1H-1,2,4-triazole (“propiconazole”) didecyldimethylammonium chloride N-didecyl-N-dipolyethoxyammonium borate/didecylpolyoxyethylammonium borate (CAS: boric acid, polymer with N-decyl-1-decanamine, oxirane (ethylene oxide) and propane-1,2-diol) 1,3-didecyl-2-methyl-1H-imidazolium chloride p-[di(iodomethyl)sulfonyl]toluene N²,N⁴-diisopropyl-6-methylthio-1,3,5-triazine-2,4-diamine (“prometryn”) dipotassium disulfite 2,6-dimethyl-1,3-dioxan-4-yl acetate (6-acetoxy-2,4-dimethyl-m-dioxane) 1,3-dimethylolurea, 1,3-bis(hydroxymethyl)urea disodium disulfite disodium ethylenebis(dithiocarbamate) (“nabam”) disodium octaborate tetrahydrate 2,2′-dithiobis[N-methylbenzamide] fenpropimorph, cis-4-[3-(p-tert-butylphenyl)-2-methylpropyl]-2,6-dimethylmorpholine fluometuron-1,1-dimethyl-3-(3-trifluoromethylphenyl)urea boric acid formaldehyde formaldehyde depot alpha, 1,3-bis(hydroxymethyl)urea, reaction products with 2-(2-butoxyethoxy)ethanol, ethylene glycol and formaldehyde 5-hydroxymethoxymethyl-1-aza-3,7-dioxabicyclo[3.3.0]octane (16.0%)/5-hydroxymethyl-1-aza-3,7-dioxabicyclo[3.3.0]octane (28.8%)/5-hydroxy-poly(methyleneoxy)methyl-1-aza-3,7-dioxabicyclo[3.3.0]octane (5.2%)/water (50%) mixture 2-(hydroxymethyl)-2-nitropropane-1,3-diol (nitromethylidinetrimethanol, “Tris Nitro”) 1-hydroxy-2(1H)-pyridinone (hydroxy-2-pyridone) imizalil, 1-[(2-allyloxy)-2-(2,4-dichlorophenyl)ethyl]-1H-imidazole technical grade imazalil, (+/−)-1-[2-(β-allyloxy)-2-(2,4-dichlorophenylethyl]-1H-imidazole 3-(4-isopropylphenyl)-1,1-dimethylurea (“isoproturon”) potassium 2-biphenoxide (potassium o-phenylphenoxide) potassium dimethyldithiocarbamate potassium sulfite lignin metam-sodium, sodium methyldithiocarbamate 2-(methoxycarbonylamino)benzimidazole (methyl benzimidazol-2-yl carbamate, “carbendazim”) 2,2′-methylenebis(4-chlorophenol)phenol (“dichlorophen”) methylene dithiocyanate L(+)-lactic acid naba, disodium ethylenebis(dithiocarbamate) sodium 2-biphenoxide (sodium o-phenylphenoxide) sodium bromide sodium p-chloro-m-cresoxide sodium dimethyldithiocarbamate sodium hydrogen-2,2′-methylenebis[4-chlorophenoxide] sodium hydrogensulfite sodium methyldithiocarbamate (“metam-sodium”) sodium o-phenylphenoxide, sodium 2-biphenoxide sodium sulfite nitromethylidinetrimethanol, 2-(hydroxymethyl)-2-nitro-1,3-propanediol oligo(2-(2-ethoxy)ethoxyethylguanidium chloride) 1-phenoxy-2-propanol/2-phenoxypropanol mixture phthalaldehyde poly(hexamethylenediamineguanidinium chloride) poly(oxy-1,2-ethanediyl)-a-[2-(didecylmethylammonium)ethyl]-w-hydroxypropanoate (“Bardap 26”) prometryn, N²,N⁴-diisopropyl-6-methylthio-1,3,5-triazine-2,4-diamine 2-propanediol, polymer with boric acid, N-decyl-1-decanamine and ethylene oxide (oxirane)—see N-didecyl-N-dipolyethoxyammonium borate/didecylpolyoxyethylammonium borate 2-propenal-propane-1,2-diol copolymer propiconazole, 1-[[2-(2,4-dichlorophenyl)-4-propyl-1,3-dioxolan-2-yl]methyl]1H-1,2,4-triazole pyridine-2-thiol 1-oxide, zinc salt (“zinc pyrithione”, “pyrithione-zinc”) sulfur dioxide silver chloride TCMTB, (benzothiazol-2-ylthio)methyl thiocyanate N,N,N′,N′-tetramethylethylenediamine-bis(2-chloroethyl) ether copolymer (N,N,N′,N′-tetramethyl-1,2-ethanediamine, polymer with 1,1-oxybis(2-chloroethane)) 2-(thiazol-4-yl)benzimidazole (“thiabendazole”) Tris Nitro, 2-(hydroxymethyl)-2-nitropropane-1,3-diol zinc pyrithione, pyridine-2-thiol 1-oxide, zinc salt

In a preferred embodiment of the invention, the use is effected with one or more biocides selected from the group of boric acid, 1,2-benzisothiazol-3-(2H)-one (BIT), 3(2H)-isothiazolone, 2-methyl, methanol [1,2-ethanediylbis(oxy)bis(glyoxal monoethylene acetal)], sodium 2-pyridinethione-1-oxide (sodium pyrithione), 1,3,5-triazine-1,3,5(2H,4H,6H)-triethanol, morpholine, 4,4′-methylenebis(1H,3H,5H)oxazolo[3,4-c]oxazole, 5-ethyl-3,7-dioxa-1-azabicyclo-[3.3.0]octane, 3-iodo-2-propynyl butyl carbamate (IPBC).

The concentration of the one or more biocides in the compositions is preferably 0.001% to 5.0% by weight, based on the ready-to-use compositions, for example based on a metalworking fluid.

The compositions may, in addition to the N-methyl-N-acylglucamines of the formula (I) used as corrosion inhibitor in accordance with the invention, comprise further corrosion inhibitors, for example organic acids and salts thereof, especially alkali metal soaps, sulfonates, amines, the anhydrides and salts thereof, benzoic acid derivatives and boron compounds.

The compositions may contain one or more additional corrosion inhibitors in amounts of 0% by weight to 10% by weight, based on the ready-to-use compositions, for example based on a metalworking fluid.

Preferably, the compositions comprise wear reducers, called AW additives, which are bound to the metal surface by adsorption and chemisorption processes and prevent metal abrasion. AW additives are zinc and phosphorus compounds, preferably zinc dithiophosphate, zinc dialkyldithiophosphate, tricresyl phosphate, chlorinated paraffins, glycerol monooleate, fatty acids and salts thereof, preferably stearic acid, dialkyl hydrogenphosphites, for example dilauryl hydrogenphosphites, commercially available as Duraphos® AP-230, trialkyl phosphites, for example trilauryl phosphite, commercially available as Duraphos® TLP.

For uses at high pressures, AW additives are ineffective and require the use of extreme pressure additives (EP additives).

EP additives used are usually sulfur and phosphorus compounds. The problematic chlorine compounds are barely still in use, if at all. Sulfur-containing additives, in the case of ferrous materials, form iron sulfide layers at the metal surface after prior adsorption and chemisorption.

Suitable examples are disulfides (inactive sulfur carriers—odorless), polysulfides, sulfurized olefins, sulfurized fatty acid esters and phosphoric esters, sulfonated olefins, zinc diphenylsulfide, methyl trichlorostearate, chlorinated naphthalene, fluoroalkylpolysiloxanes, neutralized or partly neutralized phosphates and dithiophosphates.

The compositions may comprise one or more EP additives in amounts of 0% by weight to 1% by weight, preferably 0.0005% by weight to 0.5% by weight, more preferably 0.005% by weight to 0.05% by weight, based on the ready-to-use compositions, for example based on a metalworking fluid.

In addition, the compositions may comprise defoamers, for example silicones, especially dimethylsilicone polymers, and silicic esters and alkyl methacrylates.

To improve service life, the compositions may comprise antioxidants, for example phenol derivatives such as 4,4′-methylenebis(2,6-di-tert-butylphenol), 4,4′-bis(2,6-di-tert-butylphenol), 4,4′-bis(2-methyl-6-tert-butylphenol), 2,2′-methylenebis(4-methyl-6-tert-butylphenol), 4,4′-butylidenebis(3-methyl-6-tert-butylphenol), 4,4′-isopropylidenebis(2,6-di-tert-butylphenol), 2,2′-methylenebis(4-methyl-6-nonylphenol), 2,2′-isobutylidenebis(4,6-dimethylphenol), 2,2′-5-methylenebis(4-methyl-6-cyclohexylphenol), 2,6-di-tert-butyl-4-methylphenol, 2,6-di-tert-butyl-4-ethylphenol, 2,4-dimethyl-6-tert-butylphenol, 2,6-di-tert-1-dimethylamino-p-cresol, 2,6-di-tert-4-(N,N′-dimethylaminomethylphenol), 4,4′-thiobis(2-methyl-6-tert-butylphenol), 2,2′-thiobis(4-methyl-6-tert-butylphenol), bis(3-methyl-4-hydroxy-5-tert-10-butylbenzyl) sulfide, and bis(3,5-di-tert-butyl-4-hydroxybenzyl), diphenylamine derivatives such as alkylated diphenylamines, phenyl-α-naphthylamine and alkylated α-naphthylamines. Likewise suitable are metal dithiocarbamates, especially zinc dithiocarbamate and 15-methylenebis(dibutyldithiocarbamate).

The compositions may comprise one or more antioxidants in amounts of 0% by weight to 1% by weight, preferably 0.0005% by weight to 0.5% by weight, more preferably 0.005% by weight to 0.05% by weight, based on the ready-to-use compositions, for example based on a metalworking fluid.

The compositions may comprise what are called coupling agents which boost the emulsifying action of the emulsifiers used. Preference is given to sulfonates, especially lignosulfonate, petroleumsulfonate, dodecylbenzylsulfonate, sodium salt, and sulfates, for example laurylsulfate, sodium salt.

The compositions may comprise one or more coupling agents in amounts of 0% by weight to 10% by weight, preferably 0.005% by weight to 5% by weight, more preferably 0.5% by weight to 3% by weight, based on the ready-to-use compositions, for example based on a metalworking fluid.

The compositions may additionally comprise alkali metal or alkaline earth metal salts, for example sodium carbonate, sodium hydrogencarbonate or calcium carbonate.

The compositions may comprise one or more alkali metal or alkaline earth metal salts in amounts of 0% by weight to 5% by weight, preferably 0.005% by weight to 1% by weight, more preferably 0.05% by weight to 0.8% by weight, based on the ready-to-use compositions, for example based on a metalworking fluid.

The compositions may comprise solubilizers, for example alcohols, glycols, especially butyl diglycol, propylene glycol, glycerol or sodium cumenesulfonate, in amounts of 0% by weight to 6% by weight, preferably 0.05% by weight to 5% by weight, more preferably 0.5% by weight to 4% by weight, based on the ready-to-use compositions, for example based on a metalworking fluid.

The pH of the compositions of the invention should be in the range from 7 to 12, preferably from 8 to 11.

The abovementioned compositions comprising a) to d) may be presented as a “performance packaging”.

For the production of metal treatment and metalworking fluids, in one embodiment, 5% to 40% by weight, preferably 10% to 30% by weight, more preferably 15% to 25% by weight, of the “performance packaging” are mixed with one or more oils in the amounts of 60% to 95% by weight, preferably 70% to 90% by weight, more preferably 75% to 85% by weight, based on the finished mixture of the abovementioned composition and the one or more oils. The mixtures thus obtained are referred to by the person skilled in the art as emulsion concentrates. These emulsion concentrates are diluted by the user, preferably in a volume ratio of one part emulsion concentrate to 10 to 50 parts water, and used, for example, as metal treatment and metalworking fluid.

Because of the self-emulsifying properties of the emulsion concentrates, the ready-to-use emulsions, for example metal treatment and metalworking fluids, when admixed with water, form spontaneously or after slight mechanical agitation, for example stirring. This emulsion can be used, for example, as a cleaning, anticorrosive or cooling lubricant emulsion in metalworking.

The invention therefore further provides for the use of the compositions of the invention composed of components a) to c) or a) to d) for the production of emulsion concentrates, by mixing 5% to 40% by weight, preferably 10% to 30% by weight, more preferably 15% to 25% by weight, of the composition of the invention composed of components a) to c) or a) to d) with one or more oils in an amount of 60% to 95% by weight, preferably 70% to 90% by weight, more preferably 75% to 85% by weight, based on the total amount comprising the inventive composition of components a) to c) or a) to d) and the one or more oils.

In a likewise preferred embodiment, 40% to 70% by weight, preferably 45% to 60% by weight, more preferably 50% to 55% by weight of the abovementioned inventive composition (performance packaging) comprising components a) to c) or a) to d) is mixed with one or more oils in the amounts of 30% to 60% by weight, preferably 40% to 55% by weight, more preferably 45% to 50% by weight, based on the finished mixture of the abovementioned composition and the one or more oils.

Useful oils as the one or more oils include mineral oils, especially mineral oils having kinematic viscosities of 5 to 1000, preferably 10 to 100 and exceptionally preferably 5 to 50 mm²/s, measured at 40° C., paraffins, isoparaffins, cycloparaffins (naphthenes, saturated cyclic hydrocarbons), aromatic hydrocarbons, synthetic oils, such as poly-alpha-olefins, polyalkylene glycols (PAG) and ester oils.

Preferred ester oils are:
esters of monohydric alcohols,
for example n-butyl laurate, n-butyl palmitate/stearate, n-butyl palmitate/stearate, cetylstearyl i-nonanoate, decyl oleate, 2-ethylhexyl coconut fatty acid ester, 2-ethylhexyl oleate, 2-ethylhexyl palmitate/stearate, 2-ethylhexyl tallow fatty acid ester, 2-hexyldecyl palmitate/stearate, n-hexyl laurate, i-butyl oleate, i-butyl palmitate/stearate, i-butyl tallow fatty acid ester, i-butyl mixed fatty acid ester, i-nonyl palmitate/stearate, i-propyl myristate, i-propyl palmitate, i-propyl palmitate/stearate, i-tridecyl palmitate/stearate, coconut fatty alcohol palmitate/stearate, n-octyl caprylate, oleyl erucate, oleyl oleate, cetylstearyl palmitate/stearate, cetylstearyl behenate,
glycerol esters,
for example glycerol dioleate, glycerol dipalmitate/-stearate, glycerol diesters, glycerol monobehenate, glycerol monomyristate, glycerol monooleate, glycerol monoricinoleate, glycerol mono-tallow fatty acid ester, glycerol tri-fatty acid ester, glycerol trihydrostearate, glycerol trioleate, glycerol tristearate,
polyol esters,
for example pentaerythritol tetracaprinate/-caprylate, pentaerythritol dioleate, pentaerythritol tetraoleate, pentaerythritol palmitate/stearate, polyol caprinate/caprylate, trimethylolpropane tri-fatty acid esters,
glycol esters,
for example ethylene glycol monopalmitate/-stearate, ethylene glycol dipalmitate/-stearate, polyglycol esters, polyglycol oleates, propylene glycol caprinate/caprylate, propylene glycol oleates, triethylene glycol dipalmitate/-stearate, triethylene glycol dicaprinate/-caprylate,
dicarboxylic esters,
for example di-n-butyl adipate, di-n-butyl sebacate, di-n-ethylhexyl sebacate, dioctyl adipate, dicetylstearyl phthalate, oleyl stearyl phthalate,
polyol partial esters,
for example propylene glycol caprinate/caprylate, propylene glycol oleates, triethylene glycol dipalmitate/-stearate, triethylene glycol dicaprinate/-caprylate.

### EXAMPLES

All percentages, unless stated otherwise, should be understood to mean percent by weight (% by weight).

Determination of the corrosion-inhibiting effect of a mixture of N-methyl-N—C₁₂-acylglucamine and N-methyl-N—C₁₄-acylglucamine (Glu1) and a mixture of N-methyl-N—C₁₆-acylglucamine and N-methyl-N—C₁₈-acylglucamine (Glu2) compared to demineralized water (H2O, dem.) on iron

A corrosion protection test is conducted in accordance with DIN 51360-2, in which freshly prepared solutions of (Glu1) and (Glu2) in different dilutions in demineralized water are passed through gray iron turnings (GG25 type) on a round filter. This was done by wetting the gray iron turnings on the filter paper with the solutions and, for comparison, with demineralized water for 2 hours each, and the corrosion residues formed on the filter paper were assessed.

Assessment of corrosion pursuant to DIN 51 360-2:

0 no corrosion/unchanged
1 traces of corrosion/not more than 3 corrosion marks
2 slight corrosion/not more than 1% of the surface discolored
3 moderate corrosion/not more than 5% of the surface discolored
4 severe corrosion/more than 5% of the surface discolored

The results are compiled in table 1.

TABLE 1
Corrosion of iron in the presence of
N-methyl-N-acylglucamines (Glu1)
and (Glu2), and, for comparison,
corrosion of iron in demineralized water

| Concentration | | | H₂O, |
|---|---|---|---|
| [% by wt.] | Glu2 | Glu1 | dem. |
| 5 | 3 | 3 | — |
| 10 | 2 | 3 | — |
| 15 | 0 | 2 | — |
| 100 | — | — | 4 |

Determination of the corrosion-inhibiting action of a mixture of N-methyl-N—C₁₂-acylglucamine and N-methyl-N—C₁₄-acylglucamine (Glu1) and a mixture of N-methyl-N—C₁₆-acylglucamine and N-methyl-N—C₁₈-acylglucamine (Glu2) in the presence of tall oil fatty acid (TOFA), coconut fatty acid (CC) and mono- or di- or triethanolamine in accordance with DIN 51360-2

TABLE 2
Test formulations:

| Component | | | | | | | | | |
|---|---|---|---|---|---|---|---|---|---|
| [% by wt.] | 1 | 2 | 3 | 4 | 5 | 6 | 7 | 8 | 9 |
| Glu1 | 0 | 0 | 0 | 0 | 0 | 0 | 0 | 64 | 0 |
| Glu2 | 100 | 64 | 0 | 64 | 0 | 64 | 0 | 0 | 0 |
| CC | 0 | 0 | 0 | 0 | 0 | 0 | 0 | 15 | 15 |
| TOFA | 0 | 15 | 15 | 15 | 15 | 15 | 15 | 0 | 0 |
| Monoethanolamine | 0 | 21 | 21 | 0 | 0 | 0 | 0 | 0 | 0 |
| Diethanolamine | 0 | 0 | 0 | 21 | 21 | 0 | 0 | 0 | 0 |
| Triethanolamine | 0 | 0 | 0 | 0 | 0 | 21 | 21 | 21 | 21 |
| Propylene glycol | 0 | 0 | 12.8 | 0 | 12.8 | 0 | 12.8 | 0 | 0 |
| Glycerol | 0 | 0 | 3.5 | 0 | 3.5 | 0 | 3.5 | 0 | 0 |
| Water | 0 | 0 | 47.7 | 0 | 47.7 | 0 | 47.7 | 0 | 64 |

The corrosion protection test is conducted in accordance with DIN 51360-2, by preparing 2% solutions with water having 20 German degrees of hardness (20° dH) from each of test formulations 1 to 9 from table 2 and using these solutions to wet gray iron turnings (GG25 type) on a round filter for 2 hours each and assessing the corrosion residues formed on the filter paper. The results are compiled in table 3.

TABLE 3
Corrosion of gray iron turnings in the presence
of a mixture of N-methyl-N-acylglucamines
(Glu1, Glu2), fatty acid and
alkanolamines compared to
N-methyl-N-acylglucamines (Glu2) alone
(formulation 1) and in comparison with
fatty acid and alkanolamines without
N-methyl-N-acylglucamine (3, 5 and 7 and 9)

| Test formulation | 1(C) | 2 | 3(C) | 4 | 5(C) | 6 | 7(C) | 8 | 9(C) |
|---|---|---|---|---|---|---|---|---|---|
| Corrosion protection | 2-3 | 0 | 1-2 | 0 | 1-2 | 0 | 2 | 0 | 2 |

Determination of the corrosion-inhibiting action (Glu2) in the presence of tall oil fatty acid and mono- or di- or triethanolamine on aluminum

A corrosion protection test is conducted in accordance with EEH1020-AA-1049 with the aluminum alloys AlZnMgCu1.5 and AlMgSi1. 2% test formulations from table 2 were each prepared with water having 20 German degrees of hardness (20° dH), and the test specimens of the abovementioned alloys were each half-immersed and the solutions at 40° C. and left therein for 24 hours. Thereafter, the test specimens are pulled out of the solutions, rinsed with demineralized water and then acetone, and dried. Both the part immersed into the solution (solution) and the exposed part (atmosphere) of the test specimens are assessed according to the abovementioned criteria.

The results are summarized in table 4.

TABLE 4
Corrosion of aluminum alloys in the presence of a mixture of the N-
methyl-N-acylglucamine (Glu2), fatty acid and alkanolamines (test
formulation 2, 4 and 6) compared to fatty acid and alkanolamines
without N-methyl-N-acylglucamine (test formulation 3, 5 and 7)

| | Test formulation | | | | | |
|---|---|---|---|---|---|---|
| Corrosion protection | 2 | 3(C) | 4 | 5(C) | 6 | 7(C) |
| AlZnMgCu1.5, | 1 | 3 | 0 | 1-2 | 0 | 1 |
| atmosphere | | | | | | |
| AlZnMgCu1.5 | 0 | 0 | 0 | 1 | 0 | 0 |
| solution | | | | | | |
| AlMgSi1 atmosphere | 0-1 | 3 | 0-1 | 0 | 0-1 | 2 |
| AlMgSi1 solution | 0 | 0 | 0 | 2 | 0 | 0 |

1. A method of preventing or attenuating the formation of corrosion on a metal surface, comprising the step of contacting the metal surface with a composition comprising at least one N-methyl-N-acylglucamine of the formula (I) 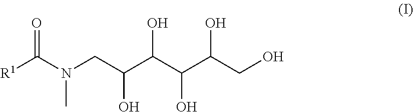
in which R¹ is a linear or branched, saturated or unsaturated hydrocarbyl group having 7 to 21 carbon atoms.

2. The method as claimed in claim 1, in which R¹ is an aliphatic group.

3. The method as claimed in claim 1, in which R¹ is a hydrocarbyl group having 11 to 17 carbon atoms.

4. The method as claimed in claim 1, in which R¹ is an alkyl or alkenyl group.

5. The method as claimed in claim 1, in which R¹ is a linear C₁₃- or C₁₇-alkyl group.

6. The method as claimed in claim 1, in which 2 to 6 different compounds of the formula (I) are employed.

7. The method as claimed in claim 1, in which the compound of the formula (I) contains at least 80% by weight of N-methyl-N—C₁₂-acylglucamine and N-methyl-N—C₁₄-acylglucamine.

8. The method as claimed in claim 1, in which the compound of the formula (I) contains at least 80% by weight of N-methyl-N—C₁₆-acylglucamine and N-methyl-N—C₁₈-acylglucamine.

9. The method as claimed in claim 1, wherein the composition further comprises at least one organic acid of the formula (II), or salts thereof,
R²—COOM (II)
in which
R² is a linear or branched alkyl group or a linear or branched, mono- or polyunsaturated alkenyl group having 5 to 29 carbon atoms, and
M is hydrogen or one or more cations, where the cations are present in charge-balancing amounts,
and
c) at least one alkanolamine of the formula (III)
NR¹R²R³ (III)
in which
R¹, R² and R³ are hydrogen, a linear or branched alkyl group having 1 to 4 carbon atoms, a cycloalkyl group having 5 to 7 carbon atoms, a linear or branched hydroxyalkyl group having 2 to 5 carbon atoms and 1 or 2 hydroxyl groups or a hydroxy ether group having 2 to 6 carbon atoms, with the proviso that at least one of the radicals is a hydroxyalkyl group or a hydroxy ether group.

10. The method as claimed in claim 9, in which R² of the formula (II) is an alkyl or alkenyl radical having 9 to 21 carbon atoms.

11. The method as claimed in claim 9, wherein the composition comprises
a) 1% to 50% by weight of one or more N-methyl-N-acylglucamines of the formula (I),
b) 0.1% to 23% by weight of at least one organic acid, or salt thereof, of formula (II) and
c) 0.05% to 42% by weight of at least one alkanolamine of formula (III) and
d) ad 100% by weight further components.

12. The method as claimed in claim 11, in which the further components are selected from the group consisting of one or more emulsifiers, one or more biocides, one or more further corrosion inhibitors, one or more AW additives, one or more EP additives, one or more defoamers, one or more antioxidants, one or more coupling agents, one or more alkali metals or alkaline earth metals, one or more solubilizers, pH regulators and water.

13. The method as claimed in claim 11, wherein 5% to 40% by weight of the composition composed of components a) to c) or a) to d) is mixed with one or more oils in an amount of 60% to 95% by weight, based on the total amount comprising components a) to c) or a) to d) and the one or more oils.

14. The method as claimed in claim 13, wherein the one or more oils are selected from the group consisting of mineral oils, paraffins, isoparaffins, cycloparaffins, naphthenes, saturated cyclic hydrocarbons, aromatic hydrocarbons, synthetic oils, poly-alpha-olefins, polyalkylene glycols (PAGs) and ester oils.

15. The method as claimed in claim 14, wherein the oil is a mineral oil.

16. A composition comprising at least one N-methyl-N-acylglucamine of the formula (I) 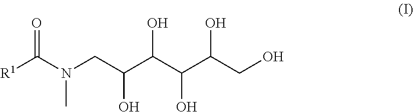
in which R¹ is a linear or branched, saturated or unsaturated hydrocarbyl group having 7 to 21 carbon atoms.

17. A detergent for metal comprising at least one composition as claimed in claim 16.

18. A cooling lubricant emulsion comprising at least one composition as claimed in claim 16.

19. A corrosion inhibitor comprising at least one composition as claimed in claim 16.
